(19) United States
(12) Patent Application Publication
(10) Pub. No.: US 2026/0357521 A1
(43) Pub. Date: Nov. 12, 2026

(54) USE OF A COMPOSITION COMPRISING A CATIONIC BIOPOLYMER

(71) Applicant: Kemira Oyj, Helsinki (FI)

(72) Inventors: Matti HIETANIEMI, Espoo (FI); Markus KORHONEN, Espoo (FI); Asko KARPPI, Espoo (FI); Jonas KONN, Espoo (FI); Natnael BEHABTU, Rochester, NY (US); Douglas ADELMAN, Rochester, NY (US); Simone KNISPEL, Espoo (FI)

(21) Appl. No.: 19/130,719

(22) PCT Filed: Nov. 15, 2023
(86) PCT No.: PCT/FI2023/050630

§ 371 Date: May 16, 2025

(30) Foreign Application Priority Data
Nov. 18, 2022 (FI) 20226035
Dec. 21, 2022 (FI) 20226141

(51) Int. Cl. D21H 17/29; C08B 37/00; C08B 37/02; C08G 65/26; C08L 5/02; D21H 21/10

(52) U.S. Cl. CPC D21H 17/29; C08B 37/0021; C08B 37/009; C08G 65/26; C08L 5/02; D21H 21/10

(57) ABSTRACT

The invention relates to a use of a composition comprising a cationic biopolymer as a drainage agent and/or as a dewatering agent in a manufacture of pulp or of a fibrous web comprising cellulosic fibres. The cationic biopolymer is selected from cationic crosslinked α-(1,3-glucan) polymers, cationic ester- or ether-derivatives of graft copolymers of dextran and α-1,3-glucan or any of their mixtures. The invention relates also to a method for increasing dewatering and/or drainage in a manufacture of pulp or of a fibrous web.

The present invention relates to a use of a composition comprising a cationic biopolymer and to a method for increasing dewatering and/or drainage in manufacture of pulp or in manufacture of a fibrous web according to the preambles of the independent claims presented below.

Dewatering is an important aspect in both in manufacture of pulp as well as in manufacture of fibrous webs, such as paper, board or the like. In manufacture of pulp, water is removed from the pulp web or pulp sheet by using press dewatering, such as twin wire presses or shoe presses. After dewatering the pulp web may be dried in a dryer comprising a number of superposed horizontal drying levels, cut into sheets and packed. Alternatively, in an integrated mill the dewatered pulp is transferred by pumping directly to a stock preparation of paper/board machine, without intermediate drying.

In manufacture of fibrous webs, such as paper and board, the water removal from a fibrous web begins immediately after its formation on a forming section. The initial removal of water, i.e. drainage, occurs by gravitation, followed by dewatering which uses dewatering elements, such as foils. Dewatering on the forming section continues then with a number of vacuum boxes, which remove water from the formed web by suction. The vacuum boxes are located one after another in a machine direction, and the vacuum, i.e. pressure drop, created by the vacuum boxes increases in the machine direction, as the water removal becomes more difficult with the increasing dryness of the web. After the forming section, the fibrous web is subjected to press dewatering by mechanical pressing of the wet web in a press section. Press dewatering may be performed, for example, by using means for press dewatering, such as a shoe press or pair of cylinders. Press dewatering has also an impact on the quality of the final fibrous web, as it increases the density of the formed web and affects its surface structure. After the press section the water content of the fibrous web may be around 30-60 weight-%. The fibrous web is then dried to the final dryness of about 93-95 weight-% in a drying section using e.g. heated cylinders and/or infrared radiators.

Dewatering is an energy-consuming part of the production of pulp and fibrous webs. Furthermore, efficient water removal secures good runnability of the process as well as aids in achieving sufficient retention and an even formation.

Drainage and dewatering efficiency of the pulp or the fibrous web may be improved by using different chemicals, either alone or as various combinations. The drainage and dewatering chemicals are usually synthetic polymers, presenting a cationic charge. However, there is an increasing interest to reduce the use of petroleum-based chemicals and to replace them with more sustainable alternatives. Due to increased environmental concern as well as legislative restrictions and incentives, there is a desire to find new additives made from bio-based, renewable resources. Preferably the new additives would be biodegradable, leaving no toxic residues. At the same time, the new additives should still provide similar or better drainage and dewatering effect. As the dewatering and drying are energy intensive processes, it is possible to obtain significant savings in energy consumption, when the drainage and dewatering is increased.

An object of the present invention is to minimise or even eliminate the disadvantages existing in the prior art.

An object of the present invention is to improve drainage and/or dewatering, especially dewatering, in manufacture of pulp or in manufacture of fibrous webs, such as paper, board or the like.

These objects are attained with the invention having the characteristics presented below in the characterising parts of the independent claims. Some preferred embodiments of the invention are presented in the dependent claims. The features recited in the dependent claims are freely combinable with each other unless otherwise explicitly stated.

A typical use of a composition comprising a cationic biopolymer according to the present invention is as a drainage agent and/or as a dewatering agent in a manufacture of pulp or of a fibrous web comprising cellulosic fibres, wherein the cationic biopolymer is selected from cationic crosslinked α-1,3-glucan polymers, cationic ester- or ether-derivatives of graft copolymers of dextran and α-1,3-glucan, or any of their mixtures.

A typical method according to the present invention for increasing dewatering and/or drainage in a manufacture of pulp or of a fibrous web comprising cellulosic fibres, comprises
obtaining a fibre suspension comprising cellulosic fibres,
adding to the fibre suspension a dewatering and/or drainage agent comprising a cationic biopolymer selected from cationic crosslinked α-1,3-glucan polymers, cationic ester- or ether-derivatives of graft copolymers of dextran and α-1,3-glucan or any of their mixtures,
forming a fibrous web of pulp, paper, board or the like,
removing water from the fibrous web, preferably by assisted dewatering.

Now it has been surprisingly found out that cationic crosslinked α-1,3-glucan polymers and cationic ester- or ether-derivatives of graft copolymers of dextran and α-1,3-glucan can be used as drainage and dewatering agents in the manufacture of pulp as well as in the manufacture of fibrous cellulosic webs. It is assumed that the crosslinked α-1,3-glucan polymers have three-dimensional structure that leads to effective interaction with the fibres either in the pulp or in the fibre suspension. The same applies for ester- and ether-derivatives of the graft copolymers, where the three-dimensional structure is created by side chains grafted to a polymer backbone. The cationic crosslinked polymer and the cationic graft copolymer derivative are not only effective drainage and/or dewatering agents but also help to achieve other desirable properties, such as effective retention during the dewatering and desired solids content of the formed web. Furthermore, the dewatering efficiency is obtained without loss of formation. The cationic α-1,3-glucan polymer and the cationic graft copolymer derivatives are able to provide dewatering and/or drainage results that are acceptable, sometimes as good as, or even better than those obtained with conventional petroleum-based polymers, such as cationic polyacrylamide, glyoxylated polyacrylamide or polyvinylamine. However, the cationic biopolymer when used according to the present invention, is able to significantly increase the sustainability of the final product.

The composition comprising the cationic biopolymer does not cause flocculation of pulp or the fibre suspension. This means that the composition is able to provide improved drainage and/or dewatering without loss of formation.

In the present context, the term “drainage” denotes removal of water from pulp or from a wet fibrous web by gravitation. A drainage agent improves the free drainage, i.e. the removal of water by gravitation from pulp or from a wet fibrous web. Mechanical water removal elements which can be used to assist the free drainage are, for example, foils, blades, forming shoes, forming rolls or forming cylinders. Drainage thus encompasses the initial water removal by gravity, for example in the beginning of the forming section, until the wet-line is achieved, i.e. the point where the change from wet to dry web can be visually observed, and air begins to go through the wet web. Typically removal of water by drainage ends when the wet web has a dryness of 3-7 weight-%.

The term “dewatering” denotes an assisted dewatering, i.e. assisted removal of water from pulp or from a wet fibrous web. Dewatering encompasses both vacuum dewatering and press dewatering. After vacuum dewatering the dryness of the pulp or the fibrous web may typically increase to a dryness of 13-23 weight-%, preferably 14-20 weight-%, more preferably 16-22 weight-%. Vacuum dewatering is typically followed by press dewatering, where dryness of the pulp or the fibrous web is increased to a dryness of 40-55 weight-%, preferably 43-52 weight-%, more preferably 45-50 weight-%. By use of dewatering agent, the dryness after vacuum dewatering can be elevated by 0-5 percentage units, and the dryness after press dewatering is elevated by 1-5 percentage units, in comparison to a situation without the dewatering agent. In vacuum dewatering the assisted removal of water can be achieved by using a vacuum, typically of 15-70 kPa. Vacuum may be achieved by using blowers, suction elements, such as vacuum boxes, vacuum pumps, or couch rolls. In press dewatering the assisted removal of water can be achieved by using pressing nips between cylinders, or by using other mechanical dewatering means, such as shoe press, centre roll press, roll press or twin wire press or the like. Dewatering also encompasses any combinations of vacuum dewatering and press dewatering, where the water is removed by using both pressing and vacuum or suction. A dewatering agent improves the dewatering, i.e. the removal of water by using suction and/or by pressing from pulp or from a wet fibrous web. For vacuum dewatering the dewatering agent has preferably the ability to provide flocculation of fines of fibre suspension without flocculation of fibres, thus achieving good web formation and high vacuum levels for effective drying. For press dewatering the dewatering agent has preferably the ability to neutralize charges of negatively charged fibres, fines and colloidal material, which are present in the pulp or in the wet web. The negative charges cause repulsion forces, which increases the distance between the fibres, fines and colloidal material, at the same time creating space for water. When the charges are neutralized, the distance between the fibres, fines and colloidal material is minimized, and the water binding capacity of the pulp or the wet web is decreased.

According to one embodiment of the present invention water may be removed from pulp or from the fibrous web by assisted dewatering employing one or more of the following: dewatering element(s), vacuum box(es), and means for press dewatering.

The present invention is especially suitable for improving the dewatering of a pulp or a wet fibrous web, such as paper, board, tissue or the like.

In the present context, the term “dextran” denotes an α-glucan comprising at least 50%, preferably at least 60%, more preferably at least 70%, even more preferably at least 80% or at least 90%, of α-1,6-glycosidic linkages, wherein the balance to 100% is typically α-1,3-glycosidic linkages. Dextran may be substantially linear, which means that is has 0-5% of branches before formation of graft copolymer with α-1,3-glucan. Possible branches in dextran itself are usually short, one to three glucose monomers in length.

In the present context the “α-1,3-glucan polymer” and “α-1,3-glucan” denotes a polymeric structure having a polysaccharide backbone which comprises D-glucose units linked together by glycosidic linkages. At least 70%, preferably at least 80%, more preferably at least 90% or 95%, sometimes even of 99% or 100%, of the glycosidic linkages are α-1,3-linkages.

The cationic biopolymer may be a cationic crosslinked α-1,3-glucan polymer. The cationic crosslinked α-1,3-glucan polymer used in the present invention comprises thus cationic substitution groups attached to its structure. The cationic substitution group may be a substituted ammonium group, preferably a quaternary ammonium group, more preferably a trialkyl ammonium group. Alkyl group in the trialkyl ammonium group may be, for example a methyl group, a hydroxymethyl group, a hydroxyethyl group or a hydroxypropyl group. The substituted ammonium group may be, for example, trimethylammonium group. The cationic substitution groups of the α-1,3-glucan polymer are able to interact with the negatively charged fibres in a manner that leads to effective drainage and/or dewatering.

The crosslinked α-1,3-glucan polymer suitable for use in the present invention may be obtained by contacting the α-1,3-glucan polymer with a crosslinker and a solvent, e.g. water. The amount of used crosslinker may be 20-5000 ppm, preferably 100-5000 ppm, calculated of polymer dry weight. According to one embodiment it is possible to use a crosslinker selected from a group comprising epihalohydrins, such as epichlorohydrin; epoxy compounds; diglycidyl ethers, such as diglycidyl ether or ethylene glycol diglycidyl ether; polyvalent metals, such as zirconium carbonate or cyanuric chloride; glyoxal; and polycarboxylic acids, such as citric acid, glutaric acid, adipic acid.

Alternatively, the cationic biopolymer suitable for use in the present invention may be a cationic ester- or ether-derivative of a graft copolymer of dextran and α-1,3-glucan. Suitable graft copolymer derivatives, methods for their preparation and determination of their glycosidic linkage profile are described, for example, in WO 2021/247810. The degree of polymerization of the α-1,3-glucan may be in a range of 20-3000, preferably 500-2000. For example, the degree of polymerisation may be in a range of 20-2000 or 55-1000. Degree of polymerization refers here to the number of glucose units comprised within an individual side chain.

According to one embodiment of the invention, the cationic graft copolymer may comprise 10-70 weight-%, preferably 20-60 weight-%, more preferably 30-50 weight-%, of dextran, calculated from the dry weight of the graft copolymer before ester or ether derivatization. The cationic graft copolymer may comprise, for example 30-90 weight-%, preferably 40-80 weight-%, more preferably 50-70 weight-%, of α-(1,3-glucan), e.g. α-1,3-glucan side chains, calculated from the dry weight of the graft copolymer before ester or ether derivatization.

According to one embodiment, the cationic biopolymer may be cationic graft copolymer comprising a dextran backbone and α-1,3-glucan side chains, where preferably the said side chains are linked to the dextran backbone via α-1,2 and/or α-1,3 and/or α-1,4 branches. The α-1,3-glucan side chains may comprise at least 70%, preferably at least 80%, more preferably at least 90% or at least 95%, sometimes even of 99% or 100%, of α-1,3-glycosidic linkages.

The graft copolymer derivatives comprise one or more cationic groups linked to the graft copolymer via an ester- or ether-linkage. The cationic group may comprise a substituted ammonium group, such as primary, secondary, tertiary or quaternary ammonium group, preferably a quaternary ammonium group, more preferably a trialkyl ammonium group. An ammonium group may be substituted with alkyl and/or aryl group(s), for example with C1-C4 alkyl or C6-C24 alkyl groups. One of the groups of the substituted ammonium group comprises one carbon or a carbon chain in ether- or ester-linkage to the graft copolymer.

According to one embodiment of the invention the composition comprises a cationic biopolymer which may have a degree of cationic substitution in the range of 0.05-1.2, preferably 0.1-1.0, more preferably 0.1-0.7, even more preferably 0.15-0.6 or 0.25-0.6. The degree of substitution refers to the average number of hydroxyl groups substituted with cationic groups via ether or ester linkage or via other linkage in each glucose unit in the graft copolymer or in the crosslinked copolymer. It has been observed that this degree of substitution provides the biopolymer with cationicity that results in effective dewatering effect, especially in press dewatering of pulp or wet fibrous web of paper, board or the like. Furthermore, the high cationicity improves the water-solubility of the biopolymer, which makes it more effective for the press dewatering. Excess cationicity is, however, preferably avoided as it may cause ecotoxicity for aquatic organisms or cause unwanted flocculation. Biopolymers with excess cationicity might also contain impurities, delimiting their suitability e.g. for food contact applications.

According to one embodiment of the invention the composition may comprise a cationic graft copolymer of dextran and α-1,3-glucan which is crosslinked. The crosslinking can be performed by using the same crosslinkers as defined above. Crosslinking of the branched structure of the graft copolymer further modifies the three-dimensionality of the cationic biopolymer.

The cationic biopolymer may have a salt viscosity of 50-5000 mPas, preferably 200-4000 mPas, measured at 2 weight-% biopolymer concentration. The viscosity can be used to measure or estimate the molecular size of the biopolymer. It has been observed that the cationic biopolymer is able to provide effective dewatering effect, especially vacuum dewatering effect, when the viscosity of the cationic biopolymer is within the given ranges. It is assumed that the size of the cationic biopolymer enables optimal floc formation, especially with the fines of the fibre suspension. The salt viscosity is measured for 2 weight-% biopolymer concentration, as active, in water in presence of a salt as follows. Cationic biopolymer is first dissolved in deionized water as 2 w-% solution, as active biopolymer. Then sodium chloride (NaCl) is added until the conductivity of the solution is 13 mS/cm. The salt viscosity of the obtained solution is determined by using a Brookfield DV1 viscometer with a small sample adapter at 25 °C. The viscosity measurement is performed by using maximum possible rotational speed.

The composition comprising the biopolymer may further comprise other chemical compounds or substances. For example, the composition may comprise salt compounds, urea compounds, cationic synthetic polymers, such as polyvinylamine or polyethyleneimine.

The composition may comprise or consist of a mixture of two or more biopolymers selected from cationic crosslinked α-1,3-glucan polymers, cationic ester- or ether-derivatives of graft copolymers of dextran and α-1,3-glucan. According to one preferable embodiment the composition consists of the biopolymer(s).

The composition comprising the cationic biopolymer may have a charge density of 0.7-5.0 meq/g, preferably 0.8-4 meq/g, more preferably 0.9-3.0 meq/g, measured by Mütek PCD. The charge density of the composition is selected to provide an effective vacuum dewatering, while avoiding problems relating to excess cationicity, such as ecotoxicity for aquatic organisms.

The composition comprising the cationic biopolymer selected from cationic crosslinked α-1,3-glucan polymers, cationic ester- or ether-derivatives of graft copolymers of dextran and alpha-glucan or any of their mixtures, is added to the aqueous fibre suspension, where it functions as drainage or dewatering agent. According to one embodiment the composition may be used in amount that provides the cationic biopolymer to the fibre suspension in amount of 0.1-0.8 kg/t, preferably 0.15-0.6 kg/t, more preferably 0.2-0.4 kg/t. The values are given as active substance.

According to one embodiment of the invention the composition comprising the cationic biopolymer is used for improving drainage and/or dewatering, especially dewatering, in a manufacture of the fibrous web, such as paper or board, which comprises or consist of recycled cellulosic fibres. In the method, an aqueous fibre suspension comprising recycled cellulosic fibres is obtained. The recycled fibres may originate from recycled paper and/or old corrugated containerboard (OCC). The fibre suspension may comprise >20 weight-%, preferably >50 weight-%, more preferably >70 weight-%, even more preferably >80 weight-% of recycled fibres, calculated from the total dry fibre weight of the suspension. The fibre suspension may even comprise 100 weight-% of recycled fibres. According to one preferable embodiment, the amount of recycled fibres in the fibre suspension may be 50-100 weight-%, preferably 80-100 weight-%, more preferably 90-100 weight-%.

When the aqueous fibre suspension comprises or consists of recycled fibres, it may have a conductivity of at least 2 mS/cm, preferably at least 3 mS/cm, more preferably at least 3.5 mS/cm. The conductivity may be in a range of 2-10 mS/cm, preferably 3-9 mS/cm, more preferably 3.5-8 mS/cm. The composition comprising the biopolymer is able to provide improvement in drainage and/or dewatering even for these fibre suspensions with high conductivity.

According to one embodiment of the invention the composition comprising the cationic biopolymer is used for improving drainage and/or dewatering, especially dewatering, in a manufacture of chemical or semi-chemical pulp or in manufacture of the fibrous web, such as paper or board, which comprises or consists of cellulosic fibres obtained by chemical pulping or semi-chemical pulping. The composition is suitable for pulps and fibres originating from chemical and semi-chemical pulping, such as kraft pulping, sulphite pulping, neutral sulphite semi-chemical (NSSC) pulping, soda pulping or chemi-thermomechanical pulping (CTMP).

The composition comprising the cationic biopolymer may be added to a fibre suspension having a consistency in the range of 0.2-20 weight-%, preferably 0.3-4 weight-%, more preferably 0.3-1.9 weight-%. When the composition is used as drainage or dewatering agent in the manufacture of fibrous web, such as paper, board or the like, the composition may be added to a thin stock having a consistency of ≤19 g/l, preferably below 15 g/l. Typically the fibre suspension may have a consistency in a range of 5-19 g/l, preferably 5-15 g/l, at the time of addition of the composition comprising the biopolymer. When the composition comprising the biopolymer is used as drainage or dewatering agent in the manufacture of pulp, the composition may be added to the pulp having a consistency of >0.5, preferably ≥3 weight-%, sometimes even ≥6 weight-%. Typically the fibre suspension may have a consistency in a range of 0.5-20 weight-%, preferably 3-15 weight-%, at the time of addition of the composition comprising the biopolymer.

When the composition is used as a dewatering agent in the manufacture of pulp, the composition may be added to a fibre suspension having a consistency in a range of 4-20 weight-%, preferably 6-20 weight-%, more preferably 8-15 weight-%.

When the composition comprising the cationic biopolymer is used in manufacture of fibrous webs, such as paper, board or the like, it can be used in combination with other papermaking chemicals. According to one embodiment of the invention, a retention aid system, for example comprising a cationic synthetic polymer, preferably cationic polyacrylamide, may be added to a fibre suspension comprising cellulosic fibres, optionally to provide at least a partial floc formation. For example, the retention aid system may comprise cationic poly(meth)acrylamide, obtained by polymerising (meth)acrylamide and 5-15 mol-% of cationic monomers, and having a weight average molecular weight in the range of 3 000 000-15 000 000 g/mol. The cationic synthetic polymer of the retention aid system may be added to the aqueous fibre suspension before or after the addition of the composition comprising the cationic biopolymer, or simultaneously with the addition of the composition comprising the cationic biopolymer. Preferably the cationic synthetic polymer is added as close to the addition of the composition comprising the cationic biopolymer as possible. The cationic synthetic polymer is preferably added before the last shear stage preceding the headbox of paper or board machine.

According to one embodiment of the invention the retention aid system may further comprise microparticles, preferably selected from inorganic siliceous microparticles, such as colloidal silica or bentonite. The inorganic siliceous microparticles may be selected from silica-based particles, silica microgels, colloidal silica, silica sols, silica gels, polysilicates, aluminosilicates, polyaluminosilicates, borosilicates, polyborosilicates, zeolites and swellable clays, such as bentonite. Preferably, inorganic siliceous microparticles are selected from colloidal silica or bentonite. The microparticles are added after the addition of the cationic synthetic polymer of the retention system, and preferably after the last shear stage preceding the headbox of a paper or board machine or the like. The microparticles may provide at least a partial reflocculation after the last shear stage.

According to one preferably embodiment of the invention, the composition comprising biopolymer may be added simultaneously with the cationic polyacrylamide, optionally followed by the addition of colloidal silica microparticles.

### EXPERIMENTAL

Some embodiments of the invention are described in the following non-limiting examples.

### Example 1

In Example 1 the effect of a cationic derivative of a graft copolymer of dextran and α-1,3-glucan on press dewatering of a fibre web comprising recycled cellulose fibres was studied.

Performance of a cationic graft copolymer derivative, i.e. branched polymer, having degree of substitution DS 0.4 was compared to a) the performance of a cationized linear non-crosslinked α-1,3-glucan polymer having a degree of substitution DS 0.4, and to b) the performance of polyvinylamine, comprising 35 mol-% of vinylamine and 65 mol-% n-vinylformamine, MW 500 000 g/mol, commonly used as a dewatering agent in paper and board machines.

The aqueous fibre suspension of 0.3% consistency was made from furnish obtained from Southern European RCF mill. Conductivity and pH of the fibre suspension were not adjusted from conductivity value 6.3 mS/cm and pH 6.1.

Solids content of the fibre web after wire section and press section as well as the initial drainage were studied with dynamic drainage analyzer (DDA). Used DDA parameters were: wire with 0.25 mm openings; vacuum 200 mbar; follow-up time 20 s.

500 ml of the fibre suspension was placed in the DDA vessel, mixing with 1000 rpm. Dewatering aid to be tested was added at 20 s before start of the drainage. Tested addition levels, given as active chemical, are given in Table 1. The retention system used was 0.2 kg/t of cationic polyacrylamide and 0.2 kg/t (as dry) of silica in each test point, addition times 10 s and 7 s before drainage, respectively.

Drainage time was measured. Wet sheet was removed after drainage from the DDA, weighed and then wet pressed at for 1 minute at 4 bar. After the wet pressing, the sheet was weighed, dried at rapid dryer and weighed anew after drying. Wire and press solids values were calculated. These values indicate the dryness of the web after vacuum dewatering and press dewatering. The results are shown in Table 1.

TABLE 1
Results of Example 1.

| | Dosage | Drainage time | Wire solids | Press solids |
|---|---|---|---|---|
| Dewatering Aid | [kg/t] | [s] | [%] | [%] |
| 0-test | — | 6.9 | 21.5 | 47.9 |
| Linear α-1,3-glucan | 0.5 | 10.6 | 21.6 | 48.5 |
| (reference) | | | | |
| Cationic graft copolymer of | 0.5 | 8.6 | 22.7 | 50.1 |
| dextran and α-1,3-glucan | | | | |
| Polyvinylamine (reference) | 0.5 | 8.1 | 21.4 | 49.1 |
| Polyvinylamine (reference) | 0.8 | 7.9 | 21.7 | 48.7 |

It can be seen from results in Table 1 that the cationic graft copolymer of dextran and α-1,3-glucan produced higher press solids and wire solids compared to references. Especially the improvement in press solids was significant, even higher than obtainable with a synthetic polymer (polyvinylamine). It is seen from Table 1 that increase of dosage does not necessarily provide better results, as exemplified by the results for polyvinylamine addition at two different levels. There seems to be an optimum dosage level for press dewatering aid, where higher dosage decreases the obtained effect.

### Example 2

In Example 2 the effect of a cationic derivative of a graft copolymer of dextran and α-1,3-glucan on press dewatering of a fibre web comprising recycled cellulose fibres was further studied by repeating Example 1, but by using a different fibre suspension.

The cationic graft copolymer derivative and the cationized linear non-crosslinked α-1,3-glucan were the same as in Example 1.

In Example 2 the aqueous fibre suspension of 0.45% consistency was made from furnish obtained from Central European RCF mill. Conductivity and pH of the fibre suspension were not adjusted from conductivity value 4.1 mS/cm and pH 6.1.

Tested addition levels for press dewatering aids, given as active chemical, are given in Table 2. The retention system was the same as in Example 1. Wet pressing of the wet sheet, after removal from DDA, was performed for 1 minute at 3.5 bar. Otherwise the procedure was identical to Example 1. The results are shown in Table 2.

TABLE 2
Results of Example 2.

| | Dosage | Drainage time | Wire solids | Press solids |
|---|---|---|---|---|
| Dewatering Aid | [kg/t] | [s] | [%] | [%] |
| 0-test | — | 13.3 | 24.5 | 47.8 |
| Linear α-1,3-glucan | 0.5 | 13.1 | 24.3 | 48.2 |
| (reference) | | | | |
| Linear α-1,3-glucan | 0.8 | 13.5 | 23.9 | 48.1 |
| (reference) | | | | |
| Cationic graft copolymer of | 0.5 | 12.0 | 24.6 | 48.4 |
| dextran and α-1,3-glucan | | | | |
| Graft copolymer of dextran | 0.8 | 11.9 | 25.0 | 48.9 |
| and α-1,3-glucan | | | | |

It can be seen from results in Table 2 that the cationic graft copolymer of dextran and α-1,3-glucan produced higher press solids and wire solids compared to linear reference. Again, the effect of optimum dosage level can be seen from Table 2, from the results obtained with the linear α-1,3-glucan reference.

### Example 3

In Example 3 the effect of cationic graft copolymer of dextran and α-1,3-glucan on press dewatering of a fibre web comprising recycled cellulose fibres was studied.

Performance of two cationic graft copolymer derivatives, i.e. branched polymers, having degree of substitution DS 0.2 and 0.4 were compared to a) the performance of two cationized linear non-crosslinked α-1,3-glucan polymers having a degree of substitution DS 0.2 and 0.4, and to b) the performance of polyvinylamine, commonly used as a dewatering agent in paper and board machines.

The aqueous fibre suspension was prepared as follows. Old corrugated containerboard (OCC) from a Central European board mill was soaked for 5 minutes at 2.5 weight-% consistency, at 85 °C in chemical water having pH 6.8. The chemical water was prepared by dissolving a salt mixture containing 70 weight-% calcium acetate, 20 weight-% sodium sulphate and 10 weight-t % sodium bicarbonate into deionized water until the conductivity was 3 mS/cm. After soaking, the OCC was hot-disintegrated at 30 000 rotations with a laboratory disintegrator. The obtained furnish was cooled to room temperature (about 23 °C) and diluted to 0.7 weight-% consistency before the experiments by using the same chemical water.

Solids content of the fibre web after wire section and press section as well as the initial drainage were studied with dynamic drainage analyzer (DDA). Used DDA parameters were: wire with 0.25 mm openings; vacuum 200 mbar; follow-up time 20 s.

500 ml of the prepared fibre suspension was placed in the DDA vessel, mixing with 1000 rpm. Dewatering aid to be tested was added at 20 s before start of the drainage. Tested addition levels, given as active chemical, are given in Table 3. The retention system used was 0.2 kg/t of cationic polyacrylamide and 0.2 kg/t (as dry) of silica in each test point, addition times 10 s and 7 s before drainage, respectively.

Drainage time was measured. Wet sheet was removed after drainage from the DDA, weighed and then wet pressed at for 1 minute at 4 bar. After the wet pressing, the sheet was weighed, dried at rapid dryer and weighed anew after drying. Wire and press solids values were calculated.

It is seen from Table 3 that the cationic graft copolymers of dextran and α-1,3-glucan significantly improve the press solids, i.e. press dewatering.

TABLE 3
Results of Example 3.

| | | Dosage | Drainage time | Wire solids | Press solids |
|---|---|---|---|---|---|
| Dewatering Aid | DS | [kg/t] | [s] | [%] | [%] |
| 0-test | | — | 7.2 | 24.5 | 47.5 |
| Linear α-1,3-glucan | 0.2 | 0.5 | 7.2 | 24.1 | 47.1 |
| (reference) | | | | | |
| Linear α-1,3-glucan | 0.2 | 0.8 | 7.9 | 23.8 | 48.3 |
| (reference) | | | | | |
| Linear α-1,3-glucan | 0.4 | 0.5 | 7.6 | 24.3 | 48.9 |
| (reference) | | | | | |
| Linear α-1,3-glucan | 0.4 | 0.8 | 7.8 | 23.9 | 48.0 |
| (reference) | | | | | |
| Cationic graft copolymer | 0.2 | 0.5 | 7.2 | 24.2 | 48.1 |
| of dextran and α-1,3- | | | | | |
| glucan | | | | | |
| Cationic graft copolymer | 0.2 | 0.8 | 7.3 | 24.0 | 49.2 |
| of dextran and α-1,3- | | | | | |
| glucan | | | | | |
| Cationic graft copolymer | 0.4 | 0.5 | 6.8 | 23.9 | 49.0 |
| of dextran and α-1,3- | | | | | |
| glucan | | | | | |
| Cationic graft copolymer | 0.4 | 0.8 | 6.9 | 24.2 | 50.0 |
| of dextran and α-1,3- | | | | | |
| glucan | | | | | |
| Polyvinylamine | | 0.8 | 8.2 | 23.6 | 49.1 |
| (reference) | | | | | |

### Example 4

In Example 4 the effect of cationic crosslinked α-1,3-glucan and the effect of cationic graft copolymer of dextran and α-1,3-glucan on press dewatering of a fibre web comprising recycled cellulose fibres was studied.

Performance of a cationic graft copolymer derivative, i.e. branched polymer, having degree of substitution DS 0.3 (salt viscosity at 2%: 178 mPas) was compared to the performance of two cationized linear crosslinked α-1,3-glucan polymers having a degree of substitution DS 0.3 (salt viscosity at 2%: 900 mPas) and DS 0.5 (salt viscosity at 2%: 26 mPas). Cationization was performed with epoxide chemistry such as 2,3-epoxypropyl trimethylammonium chloride (EPTAC). Cationic crosslinked α-1,3-glucan polymers were prepared from α-1,3-glucan, DP 1500, by adding polyethyleneglycol diglycidyl ether (EDGE) as crosslinker to the cationization step. The crosslinker amount was adjusted to a level, where Brookfield DV1 SSA viscosity of the polymer was increased to about 3 times compared to viscosity of the start polymer at 3% concentration and at 25 °C temperature.

The aqueous fibre suspension was prepared as follows. Old corrugated containerboard (OCC) from a Central European board mill was soaked for 5 minutes at 2.5 weight-% consistency, at 85 °C in chemical water, as in Example 3. After soaking, the OCC was hot-disintegrated at 30 000 rotations with a laboratory disintegrator. The obtained furnish was cooled to room temperature (about 23 °C) and diluted to 0.7 weight-% consistency before the experiments by using the same chemical water.

Solids content of the fibre web after wire section and press section as well as the initial drainage were studied with dynamic drainage analyzer (DDA). Used DDA parameters were: wire with 0.25 mm openings; vacuum 300 mbar; follow-up time 15 s.

500 ml of the prepared fibre suspension was placed in the DDA vessel, mixing with 1000 rpm. Dewatering aid to be tested was added at 20 s before start of the drainage. Tested addition levels, given as active chemical, are given in Table 4. The retention system used was 0.2 kg/t (as dry) of cationic polyacrylamide and 0.2 kg/t (as dry) of silica in each test point, addition times 10 s and 7 s before drainage, respectively.

Drainage time was measured. Wet sheet was removed after drainage from the DDA, weighed and then wet pressed at for 1 minute at 4 bar. After the wet pressing, the sheet was weighed, dried at rapid dryer and weighed anew after drying. Wire and press solids values were calculated. These values indicate the dryness of the web after vacuum dewatering and press dewatering.

It is seen from Table 4 that both cationic crosslinked α-1,3-glucan polymers and the cationic graft copolymers of dextran and α-1,3-glucan improved the press solids, i.e. press dewatering. Cationic crosslinked α-1,3-glucan polymers improved vacuum dewatering, which is seen in wire solids value. Lower dosage (0.5 kg/t) of cationic graft copolymer improved the wire solids value more than a higher dosage (0.8 kg/t). This indicated again that micro-floc formation for vacuum dewatering has an optimum dosage, which depends on used polymer as well as the used fibre suspension.

TABLE 4
Results of Example 4.

| | | Dosage | Wire solids | Press solids |
|---|---|---|---|---|
| Dewatering aid | DS | [kg/t] | [%] | [%] |
| 0-test | — | — | 21.6 | 49 |
| (only retention aids) | | | | |
| Cationic crosslinked α-1,3- | 0.3 | 0.5 | 22.0 | 51 |
| glucan polymer | | | | |
| Cationic crosslinked α-1,3- | 0.5 | 0.5 | 21.7 | 51 |
| glucan polymer | | | | |
| Cationic graft copolymer of | 0.3 | 0.5 | 22.4 | 51 |
| dextran and α-1,3-glucan | | | | |
| Cationic graft copolymer of | 0.5 | 0.8 | 22.0 | 51 |
| dextran and α-1,3-glucan | | | | |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. (canceled)

2. The method according to claim 15, wherein the cationic graft copolymer comprises 10-70 weight-%, preferably 20-60 weight-%, more preferably 30-50 weight-%, of dextran, calculated from the dry weight of the graft copolymer before ester or ether derivatization.

3. The method according to claim 15, that wherein the cationic graft copolymer comprises 30-90 weight-%, preferably 40-80 weight-%, more preferably 50-70 weight-%, of α-(1,3-glucan), calculated from the dry weight of the graft copolymer before ester or ether derivatization.

4. The method according to claim 15, wherein the cationic biopolymer is cationic graft copolymer comprising a dextran backbone and α-(1,3-glucan) side chains.

5. The method according to claim 15, wherein the cationic graft copolymer is crosslinked.

6. The method according to claim 15, wherein the cationic crosslinked biopolymer is obtained by using a crosslinker selected from a group comprising epihalohydrins, epoxy compounds, diglycidyl ethers, polyvalent metals, glyoxal and polycarboxylic acids.

7. The method according to claim 15, wherein the cationic biopolymer has a salt viscosity of 50-5000 mPas, preferably 200-4000 mPas, measured at 2 weight-% biopolymer concentration.

8. The method according to claim 15, wherein the cationic biopolymer has a degree of cationic substitution 0.05-1.2, preferably 0.1-1.0, more preferably 0.1-0.7, even more preferably 0.15-0.6.

9. The method according to claim 15, wherein the composition comprising the cationic biopolymer has a charge density of 0.7-5.0 meq/g, preferably 0.8-4 meq/g, more preferably 0.9-3.0 meq/g.

10. The method according to claim 15, wherein the manufacture of the fibrous web comprises recycled cellulosic fibres and/or cellulosic fibres obtained by chemical pulping or semi-chemical pulping.

11. The method according to claim 15, wherein the composition is used in amount that provides the cationic biopolymer in amount of 0.1-0.8 kg/t, preferably 0.15-0.6 kg/t, more preferably 0.2-0.4 kg/t.

12. The method according to claim 15, wherein the composition comprising the cationic biopolymer is added to a fibre suspension having a consistency in the range of 0.2-20 weight-%, preferably 0.3-4 weight-%, more preferably 0.3-1.9 weight-%.

13. The method according to claim 15, wherein a retention aid system, preferably comprising cationic polyacrylamide, is added to a fibre suspension comprising cellulosic fibres.

14. The method according to claim 13, wherein the retention aid system comprises microparticles, such as colloidal silica.

15. A method for increasing dewatering and/or drainage in a manufacture of pulp or of a fibrous web comprising cellulosic fibres, the method comprising
obtaining a fibre suspension comprising cellulosic fibres,
adding to the fibre suspension a composition comprising a dewatering and/or drainage agent comprising a cationic biopolymer selected from cationic crosslinked α-(1,3-glucan) polymers, cationic ester- or ether-derivatives of graft copolymers of dextran and alpha-glucan or any of their mixtures,
forming a fibrous web of pulp, paper, board or the like,
removing water from the fibrous web, preferably by assisted dewatering.

16. The m method according to claim 15, wherein water is removed from the fibrous web by assisted dewatering employing one or more of the following: dewatering element(s), vacuum box(es), and means for press dewatering.
